(19) United States
(12) Patent Application Publication
(10) Pub. No.: US 2013/0226827 A1
(43) Pub. Date: Aug. 29, 2013

(54) Enhanced Clearing House Collateral Management System with Capabilities to Transfer Excess Collateral to Other Users

(71) Applicant: Richard John Stevens, Tonbridge (GB)

(72) Inventor: Richard John Stevens, Tonbridge (GB)

(73) Assignee: CHICAGO MERCANTILE EXCHANGE INC., Chicago, IL (US)

(21) Appl. No.: 13/403,727

(22) Filed: Feb. 23, 2012

(51) Int. Cl. G06Q 40/06

(52) U.S. Cl. 705/36 R

(57) ABSTRACT

Systems and methods are disclosed involving central clearing of forward contracts and/or other financial instruments. In particular, systems and methods for, among other things, transferring excess collateral between clearing members of a clearing house are disclosed. In some examples, systems and methods for efficient transfer of excess forward position collateral between the clearing members of a clearing house is disclosed. In some examples, the transferring may occur in the form of a sale and repurchase transaction (e.g., a “repo” transaction).

### TECHNICAL FIELD

The disclosure involves central clearing of forward contracts and/or other financial instruments. In particular, systems and methods for, among other things, transferring excess collateral between clearing members are disclosed.

### BACKGROUND

Over-the-counter (OTC) financial derivative products are generally financial instruments or investment vehicles that include custom-tailored, negotiated contracts that are bought, sold, or otherwise exchanged between parties. That is, the OTC financial derivatives are typically not exchange traded. OTC derivatives may include options, forward contracts, foreign exchange (FX) spot and forward contracts, stocks, securities, bonds and any other financial product or investment vehicle that may be traded between parties.

It is desirable for the products to have a payoff that can be easily tracked or monitored using a computer model that may produce a theoretical value for closing and/or settlement purposes. Typically, the settlement or payoff for an OTC derivative may be determined according to conventional International Swap and Derivatives Association (ISDA) rules. The open position on a financial product may be periodically determined prior to expiry through a mark-to-market accounting process where the position is determined according to an agreed upon standard or benchmark. The standard or benchmark may fluctuate or vary with changes in the market. The final payoff may be determined for the derivative product as calculated according to the benchmark at expiration of the product.

Regarding clearing houses, Wikipedia.com explains that a “clearing house is a financial institution that provides clearing and settlement services for financial and commodities derivatives and securities transactions. These transactions may be executed on a futures exchange or securities exchange, as well as off-exchange in the over-the-counter (OTC) market. A clearing house stands between two clearing firms (also known as member firms or clearing participants) and its purpose is to reduce the risk of one (or more) clearing firm failing to honor its trade settlement obligations. A clearing house reduces the settlement risks by netting offsetting transactions between multiple counterparties, by requiring collateral deposits (a.k.a. margin deposits), by providing independent valuation of trades and collateral, by monitoring the credit worthiness of the clearing firms, and in many cases, by providing a guarantee fund that can be used to cover losses that exceed a defaulting clearing firm's collateral on deposit. Once a trade has been executed by two counterparties either on an exchange, or in the OTC markets, the trade can be handed over to a clearing house which then steps between the two original traders' clearing firms and assumes the legal counterparty risk for the trade. This process of transferring the trade title to the clearing house is called novation. It can take fractions of seconds in highly liquid futures markets; or days, or even weeks in some OTC markets. As the clearing house concentrates the risk of settlement failures into itself and is able to isolate the effects of a failure of a market participant, it also needs to be properly managed and well-capitalized in order to ensure its survival in the event of a significant adverse event, such as a large clearing firm defaulting or a market crash. Many clearing house guarantee funds are capitalized with collateral from its clearing firms. In the event of a settlement failure, the clearing firm may be declared to be in default and clearing house default procedures may be utilized, which may include the orderly liquidation of the defaulting firm's positions and collateral. In the event of a significant clearing firm failure, the clearing house may draw on its guarantee fund in order to settle trades on behalf of the failed clearing firm.”

CME Group has, at one point in time, offered clearing of privately-negotiated deals, submitted via CME ClearPort, in Cleared OTC London Gold Forward contracts. See “Clearing and Bookkeeping Processing for Forwards,” which is publicly available online as well as is being submitted concurrently with this application filing, and which is incorporated by reference herein. Generally customer positions in forwards were considered “OTC contracts”, and were part of the 30.7 Secured regulatory class. As such, regulations required that these positions, and associated money and collateral deposits, must be kept separate from both “customer segregated” futures positions and money amounts, and proprietary (house) amounts. In the clearing system, trades in forward products marked as “customer”, would be posted to a special position account denoted with a trailing “S” (for “30.7 Secured.”) Mark to market amounts and performance bond requirements would similarly be aggregated to a special “S” Customer Non-Segregated settlement account, and a separate pool of collateral assets would be deposited to meet those performance bond requirements.

At one point in time, regulations required that regulatory class 30.7 forwards recognize risk offsets between customer positions in segregated futures versus 30.7 forwards. See “Clearing and Bookkeeping Processing for Forwards,” which is publicly available online as well as is being submitted concurrently with this application filing, and which is incorporated by reference herein. Generally risk offsets were not allowed. For example, suppose a customer account is long in COMEX gold futures, and short in COMEX OTC London gold forwards. This risk offset may not be recognized, and the customer margin requirement for neither futures nor forwards may not be correspondingly reduced. Note also that collateral deposited to meet customer-segregated margin requirements may not be used to meet either initial margin or collateralized mark-to-market requirements for 30.7 products, and vice versa. Also, if a customer has a collateralized mark-to-market amount for a 30.7 product which is a credit (a net gain), this may be used to offset performance bond requirements only for such 30.7 Secured positions. If there is any excess credit, it cannot be used to offset requirements from normal customer-segregated futures positions. One or more of the aforementioned regulations related to 30.7 positions may have been deprecated by or used in addition to a ‘Cleared OTC Customer’ regulatory class governed by CFTC Regulation 190.

### SUMMARY

The present disclosure overcomes limitations of the prior art by providing methods and systems that provide an enhanced clearing house collateral management system with capabilities to transfer excess collateral to other users, as well as other features.

An embodiment may include a method of calculating an excess collateral credit amount and transferring the excess collateral credit amount to another user. In some examples, the method may include calculating an amount of a performance bond requirement, and offsetting the performance bond requirement using a credit resulting from at least an increased valuation of a user's portfolio based on a mark-to-market assessment. The method may also include receiving collateral assets from a user to allocate towards the performance bond requirements of the user's portfolio, and releasing these collateral assets when appropriate. The other user receiving the excess collateral credits may offset his/her own performance bond requirements using these credits. This other user may pay the user providing the excess collateral credit a fee or some other benefit.

In addition, a computer system with a processor and memory is disclosed for implementing one or more of the aforementioned steps of the method of transferring excess collateral credit. Aspects of the computer system may be located at a clearing house or may be distributed over a network interconnecting multiple clearing houses and/or exchanges. Of course, the methods and systems of the above-referenced embodiments may also include other additional elements, steps, computer-executable instructions or computer-readable data structures. In this regard, other embodiments are disclosed and claimed herein as well. For example, the computer system may comprise a computer processor and a tangible computer memory storing computer-executable instructions, which when executed by the processor, cause the computer system to perform one or more of the steps described herein. The details of these and other embodiments of the present disclosure are set forth in the accompanying drawings and the description below. Other features and advantages of the disclosure will be apparent from the description and drawings and from the claims.

### BRIEF DESCRIPTION OF THE DRAWINGS

The various aspects of the disclosure are illustrated by way of example and not limited in the accompanying figures in which like reference numerals indicate similar elements and in which:

FIG. 1 shows a computer network system that may be used to implement various aspects of the embodiments disclosed in accordance with the disclosure;

FIG. 2 is a diagram of some components of an illustrative clearing house collateral management system in accordance with aspects of the disclosure;

FIGS. 3A, 3B, 3C, and 3D are graphical illustrations of one example of a method of transferring excess collateral between clearing members in accordance with aspects of the disclosure; and

FIG. 4 is a flowchart illustrating various steps that may be performed in accordance with aspects of the disclosure.

### DETAILED DESCRIPTION

The disclosure involves central clearing of forward contracts and/or other financial instruments. In particular, systems and methods for, among other things, transferring excess collateral between clearing members are disclosed. In some examples, the transferring may occur in the form of a sale and repurchase transaction (e.g., a “repo” transaction).

A clearing house collateral management system in accordance with various aspects of the disclosure may be used to assist in transferring collateral credit between users (e.g., members of the clearing house, such as initiating members and responding members), calculating collateral asset requirements, adjusting collateral assets requirements based on market fluctuations, and/or securing/releasing collateral assets. The clearing house collateral management system may enable users (e.g., clearing members, traders, etc.) of the clearing house to make use of the profit on a forward position which is in excess of the position holder's performance bond requirement for his/her portfolio. Various features disclosed herein provide a clearing house collateral management system enhanced to provide the ability to make efficient use of this profit or excess collateral credit. Aspects of the disclosure improve the efficiency of capital use by ensuring that the form of collateral credit created by a clearing house collateral management system can be used to a greater extent and ensure that a price (e.g., fee) is established for its use. Moreover, additional benefits of such an enhanced clearing house collateral management system is that it provides greater confidence to users (e.g. customers, traders, members, etc.) to use a centrally-cleared environment (e.g., a clearing house, exchange) for forward positions and other financial instruments.

In accordance with various aspects of the disclosure, a second user (e.g., responding member of a clearing house) may benefit from the excess collateral credit in another user's collateral account (e.g., an initiating member). The initiating user may send his/her collateral credit, which in excess of any performance bond requirement (or other collateral/margin requirement) of the clearing house, to the responding member for the responding member's use in meeting collateral/margin requirements with the clearing house. The clearing house collateral management system may calculate, receive, offset, release, and/or transfer the collateral credit and collateral requirements for each of the users. In some examples, the collateral credit may be applied towards accounts other than collateral asset accounts (e.g., to meet a margin requirement). In addition, in some examples the extra collateral that is transferred between clearing members may be used to discharge (or offset) performance bond requirements.

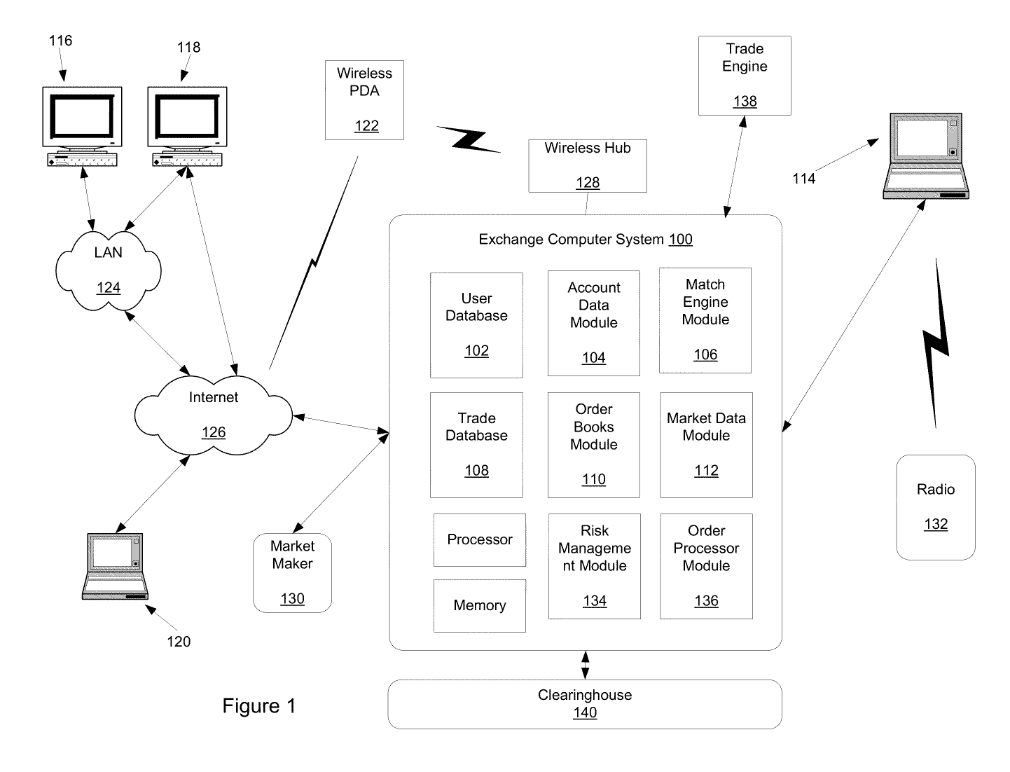

FIG. 1 depicts an illustrative operating environment that may be used to implement various aspects of the disclosure. The operating environment is only one example of a suitable operating environment and is not intended to suggest any limitation as to the scope of use or functionality of the various embodiment of the disclosure. Aspects of the present disclosure are preferably implemented with computing devices and networks for exchanging, transmitting communicating, administering, managing and facilitating trading information including, but not limited to performance bond amount requirements and trading information. An exchange computer system 100 receives market data, analyzes historical data, and calculates various values, e.g., performance bond amounts, in accordance with aspects of the disclosure.

Exchange computer system 100 may be implemented with one or more mainframes, servers, gateways, controllers, desktops or other computers. The exchange computer system 100 may include one or more modules, processors, databases, mainframes, desktops, notebooks, tablet PCs, handhelds, personal digital assistants, smartphones, gateways, and/or other components, such as those illustrated in FIG. 1. Moreover, computer system 100 may include one or more processors (e.g., Intel® microprocessor, AMD® microprocessor, risk processor, etc.) and one or more memories (e.g., solid state, DRAM, SRAM, ROM, Flash, non-volatile memory, hard drive, registers, buffers, etc.) In addition, an electronic trading system 138, such as the Globex® trading system, may be associated with an exchange 100. In such an embodiment, the electronic trading system includes a combination of globally distributed computers, controllers, servers, networks, gateways, routers, databases, memory, and other electronic data processing and routing devices. The trading system may include a trading system interface having devices configured to route incoming messages to an appropriate devices associated with the trading system. The trading system interface may include computers, controllers, networks, gateways, routers and other electronic data processing and routing devices. Orders that are placed with or submitted to the trading system are received at the trading system interface. The trading system interface routes the order to an appropriate device. A trading engine computer system 100 receives orders and transmits market data related to orders and trades to users.

A user database 102 may include information identifying traders and other users of exchange computer system 100. Such information may include user names and passwords. A trader operating an electronic device (e.g., computer devices 114, 116, 118, 120 and 122) interacting with the exchange 100 may be authenticated against user names and passwords stored in the user database 102. Furthermore, an account data module 104 may process account information that may be used during trades. The account information may be specific to the particular trader (or user) of an electronic device interacting with the exchange 100.

A match engine module 106 may match bid and offer prices for orders configured in accordance with aspects of the disclosure. Match engine module 106 may be implemented with software that executes one or more algorithms for matching bids and offers for bundled financial instruments in accordance with aspects of the disclosure. The match engine module 106 and trading system interface may be separate and distinct modules or component or may be unitary parts. Match engine module may be configured to match orders submitted to the trading system. The match engine module may match orders according to currently known or later developed trade matching practices and processes. In an embodiment, bids and orders are matched on price, on a FIFO basis. The matching algorithm also may match orders on a pro-rata basis or combination of FIFO and pro rata basis. Other processes and/or matching processes may also be employed.

Moreover, a trade database 108 may be included to store historical information identifying trades and descriptions of trades. In particular, a trade database may store information identifying or associated with the time that an order was executed and the contract price. The trade database 108 may also comprise a storage device configured to store at least part of the orders submitted by electronic devices operated by traders (and/or other users). A confirmation message may be sent when the match engine module 106 finds a match for an order and the order is subsequently executed. The confirmation message may, in some embodiments, be an e-mail message to a trader, an electronic notification in one of various formats, or any other form of generating a notification of an order execution.

Furthermore, an order book module 110 may be included to compute or otherwise determine current bid and offer prices. The order book module 110 may be configured to calculate the price of a financial instrument.

A market data module 112 may be included to collect market data and prepare the data for transmission to users. The market data module 112 may also, in some examples, distribute market and order data to users and/or other modules in a clearing house and/or exchange network. In some examples, the market data modules 112 may also perform mark-to-market assessments of financial instruments at regular intervals (e.g., daily, weekly, hourly, continuously, etc.) One or more of these financial instruments may be a part of a user's portfolio. One or more of the aforementioned functionality may be performed by the market data module 112 alone, or by the market data module 112 in combination with or with the assistance of another module/processor.

In addition, a risk management module 134 may be included in computer system 100 to compute and determine the amount of risk associated with a financial product or portfolio of financial products. The risk management module 134 may, in some examples, process and manage collateral assets of users, including, but not limited to requesting additional margin from users when appropriate. The risk management module 134 may also calculate performance bond (i.e., margin) requirements based on at least a user's portfolio and/or mark-to-market assessments. One or more of the aforementioned functionality may be performed by the risk management module 134 alone, or by the risk management module 134 in combination with or with the assistance of another module/processor.

An order processor module 136 may be included to receive data associated with an order for a financial instrument. The module 136 may decompose delta based and bulk order types for processing by order book module 110 and match engine module 106. The order processor module 136 may be configured to process the data associated with the orders for financial instruments.

The trading network environment shown in FIG. 1 includes computer (i.e., electronic) devices 114, 116, 118, 120 and 122. The computer devices 114, 116, 118, 120 and 122 may include one or more processors, or controllers, that control the overall operation of the computer. The computer devices 114, 116, 118, 120 and 122 may include one or more system buses that connect the processor to one or more components, such as a network card or modem. The computer devices 114, 116, 118, 120 and 122 may also include interface units and drives for reading and writing data or files. Depending on the type of computer device, a user can interact with the computer with a keyboard, pointing device, microphone, pen device or other input device. For example the electronic device may be a personal computer, laptop or handheld computer, tablet pc and like computing devices having a user interface. The electronic device may be a dedicated function device such as personal communications device, a portable or desktop telephone, a personal digital assistant (“PDA”), remote control device, personal digital media system and similar electronic devices.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a local area network (LAN) 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

The operations of computer devices and systems shown in FIG. 1 may be controlled by computer-executable instructions stored on computer-readable storage medium. Embodiments also may take the form of electronic hardware, computer software, firmware, including object and/or source code, and/or combinations thereof. Embodiment may be stored on computer-readable media installed on, deployed by, resident on, invoked by and/or used by one or more data processors (e.g., risk processor), controllers, computers, clients, servers, gateways, networks of computers, and/or any combinations thereof. The computers, servers, gateways, may have one or more controllers configured to execute instructions embodied as computer software. For example, computer device 114 may include computer-executable instructions for receiving interest rate and other information from computer system 100 and displaying to a user. In another example, computer device 118 may include computer-executable instructions for receiving market data from computer system 100 and displaying that information to a user. In yet another example, a processor of computer system 100 may be configured to execute computer-executable instructions that cause the system 100 to calculate a performance bond amount required to balance risk associated with a portfolio.

One or more market makers 130 may maintain a market by providing bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems. Coupling can be direct as described or any other method described herein.

A clearinghouse 140 enables an exchange computer system 100 to provide contracts with a lower likelihood of default than over-the-counter (OTC) products. A clearinghouse 140 arranges for transactions to be settled and cleared. Clearing is the procedure through which a clearinghouse 140 becomes buyer to each seller of a contract (e.g., futures contract, equities, currencies, interest rate products, etc.), and seller to each buyer, and assumes responsibility for protecting buyer and seller from financial loss by assuring performance on each contract. A clearinghouse 140 may settle trading accounts, clear trades, collect and maintain performance bond funds, regulate delivery and report trading data. In some scenarios an exchange may operate its own clearinghouse 140 through a division of the exchange through which all trades made are confirmed, matched, and settled each day until offset or delivered. Alternatively, one or more other companies may be provided the responsibility of acting as a clearinghouse 140 with the exchange (and possibly other exchanges). An exchange may have one or more clearinghouses associated with the exchange. An exchange may offer firms qualified to clear trades to provide a clearinghouse 140 for the exchange computer system 100. In some instances, these clearing members may be designated into different categories based on the type of commodities they can clear and other factors.

The clearinghouse 140 may establish minimum performance bond (i.e., margin) requirements for the products it handles. A customer may be required to deposit a performance bond with the clearinghouse 140 (or designated account) for the purpose of insuring the clearinghouse 140 against loss on open positions. The performance bond helps ensure the financial integrity of brokers, clearinghouses, and exchanges as a whole. If a trader experiences a drop in funds below a minimum requirement, the clearinghouse 140 may issue a margin call requiring a deposit into the margin account to restore the trader's equity. A clearinghouse 140 may charge additional performance bond requirements at the clearinghouse's discretion. For example, if a clearinghouse's potential market exposure grows large relative to the financial resources available to support those exposures, the clearinghouse 140 may issue a margin call.

In another embodiment, the clearinghouse 140 may require a larger performance bond based on a credit check (e.g., an analysis of the credit worthiness, such as using a FICO™ or comparable score, inter alia) of the customer/trader. The credit check may be performed (i.e., initiated) by a clearinghouse 140 or an exchange 100. In the example where the clearinghouse 140 performs the credit check, the clearinghouse 140 may send a message (e.g., enforcement message) to the exchange 100. If the credit check indicates that a customer/trader is a high risk, the enforcement message may increase the margin requirements of the customer/trader, or otherwise adjust the capabilities/constraints of the customer/trader commensurate with the higher risk. In the example where the exchange 100 initiates the credit check, the exchange 100 may send a message to one or more clearinghouses associated with the exchange 100 to update them on the increased/decreased risk associated with the customer/trader.

In recognition of the desire to promote efficient clearing procedures and to focus on the true intermarket risk exposure of clearinghouses, a cross-margining system may be used. By combining the positions of joint and affiliated clearinghouses in certain broad-based equity index futures and options into a single portfolio, a single performance bond requirement across all markets may be determined. The cross-margining system may greatly enhance the efficiency and financial integrity of the clearing system.

The principal means by which a clearinghouse 140 mitigates the likelihood of default is through mark-to-market (MTM) adjustments. The clearinghouse 140 derives its financial stability in large part by removing debt obligations among market participants as they occur. Through daily (or at other intervals) MTM adjustments, every contract is debited or credited based on that trading session's gains or losses. For example, as prices move for or against a position, funds flow into or out of the trading account. This cash flow is known as settlement variation.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

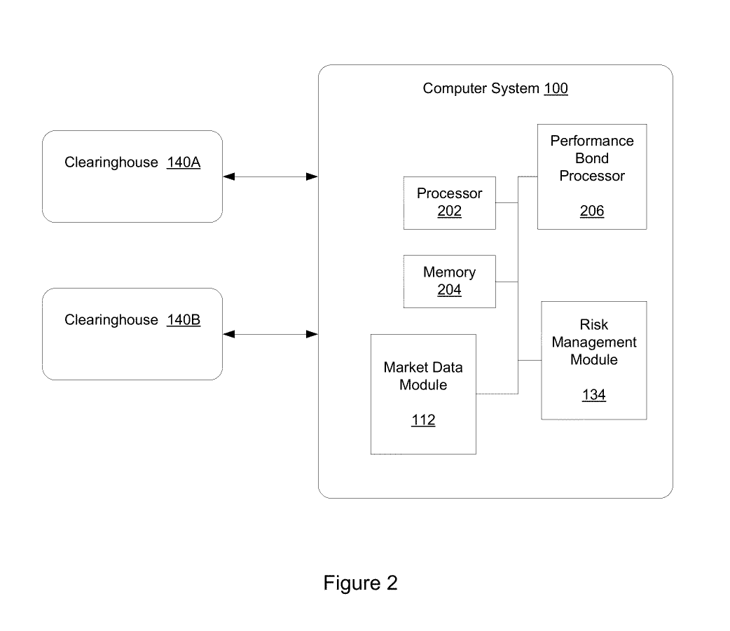

FIG. 2 is a diagram of some components of an illustrative clearing house collateral management system in accordance with aspects of the disclosure. The clearing house collateral management system may be located at an exchange computer system 100, as depicted in FIG. 2, or may be located elsewhere, such as at a clearing houses 140A, 140B. The clearing house collateral management system may comprise at least one or more components, such as, but not limited to, a performance bond processor 206, a risk management module 134, a market data module 112, processor 202 (e.g., a RISC-based general microprocessor, etc.), memory 204 (e.g., computer memory, etc.) and other modules/processors/components. In some example in accordance with aspects of the disclosure, one or more of the aforementioned components of the clearing house collateral management system may be distributed over a network of connected computers, and they may communicate and collaborate to provide the capabilities of an enhanced clearing house collateral management system as described herein. As such, the clearing house collateral management system may not be physically located at one computer, but may be distributed over a network of computing devices. Alternatively, in some example, the clearing house collateral management system may be combined into a single component/module/processor that is configured to provide the functionality of the various aforementioned components.

The performance bond processor 206 of the clearing house collateral management system, in some examples, may be configured to calculate an amount of a performance bond requirement based on at least a user's portfolio. The user's portfolio may comprise forward contracts (e.g., FX forward contracts) and/or other financial instruments. Moreover, the performance bond processor 206 may comprise a margin amount generator and a margin adjustment processor to assist with one or more of the functions provided by the performance bond processor 206. The margin amount generator may receive input representing the portfolio of products/positions and compute an initial performance bond/margin requirement for the user. The required amount of the performance bond may change with market fluctuations and other factors. In some examples, where there is a high correlation between one or more of the products/positions of the portfolio, the requisite performance bond may be lessened to reflect the reduced risk. In some examples, the margin amount generator may be in communication with a margin adjustment processor and other components (e.g., an asset correlation processor and/or risk management module 134), and the margin adjustment processor may adjust the margin requirement based on a correlation (or risk assessments) provided by these other components (i.e. compute the risk assessment for the user's portfolio). For example, the risk management module 134 may offset the performance bond requirement for a user using a credit resulting from at least an increased valuation of the user's portfolio. The clearing house collateral management system illustrated in FIG. 2 may collectively perform one or more steps of: computing an initial margin requirement based on the portfolio; receiving at least one asset as collateral to fulfill the margin requirement; correlating the at least one asset to at least one of the plurality of products in the portfolio; and/or adjusting the margin requirement based on the correlation. In some embodiments, the adjusting is in proportion to the correlation. For example, the margin requirement is decreased as the correlation increases.

Various techniques and components (e.g., margin amount generator and margin adjustment processor) for computing performance bond amounts and adjusting margin requirements are discussed in currently commonly-assigned U.S. Pat. No. 7,426,487 entitled, “System and method for efficiently using collateral for risk offset,” which is incorporated by reference herein in its entirety. One or more of the teachings of the aforementioned commonly-assigned U.S. patent may be used in conjunction with the methods and systems in this disclosure. In one example, the performance bond requirement for FX forwards may consist of two components: an equity component (i.e., the cumulative mark-to-market amount on open trades being collateralized) and a risk component (i.e., the maximum reasonably-likely loss that may occur until the next day that additional collateral may be collected, as evaluated by SPAN®.) Note that the equity requirement may include an adjustment up to protect against the customer defaulting only on losing delivery obligations. In evaluating the risk component, the SPAN file may provide intercommodity spreads between FX futures and FX forward positions. To simplify the evaluation of the intercommodity spreads and generally to simplify the process of margining the FX forward positions in SPAN, they may be converted in futures-equivalent positions (e.g., by dividing the nominal position by a conversion factor and then rounding the result to the nearest integer.) The disclosure contemplates that there are numerous different techniques known in the art for calculating the margin requirements for a user's portfolio/portfolios of diverse financial instruments, and one of or more of these other calculations may be used in different examples in accordance with aspects of the disclosure.

In some examples, the performance bond processor 206 may calculate a collateral credit amount that is greater than the required amount of a performance bond. In such scenarios, the clearing house collateral management system may present the excess collateral credit to the user for use. Prior art clearing house collateral management systems were incapable of making this collateral credit, which is in excess of the performance bond requirement, available to the user for use in generating additional profit/fees. Instead, prior art clearing house collateral management systems left the collateral credit in the user's collateral account without the capability to make efficient use of these credits.

In accordance with this disclosure, an enhanced clearing house collateral management system is disclosed herein that enables a user to transfer the collateral credits to another user (e.g., a user at the same clearing house or at a different clearing house). The other user may, in some examples, use the collateral credit to offset any margin requirements enforced by a clearing house on that user's portfolio. In exchange, the user receiving the collateral credit may pay the other user a fee for the use of the collateral credit. In some examples the transfer may be temporary such that upon the expiration of a period of time (e.g., one business day), the collateral credit amount may be transferred back to the original user. In some examples, the aforementioned fee may include any interest (e.g., at a predetermined interest rate) charges on the borrowed collateral credit, any fees that may have been charged, or any other amount of funds transferred from the second user to the user, either directly or indirectly, such as through an exchange or central counterparty. In another example, a clearing house 140 or exchange acting as a central counterparty may assist in identifying the second user based on the second user requiring additional collateral assets to meet the performance bond requirement for its portfolio. The second user may have expressly requested the collateral credit from the clearing house collateral management system, or alternatively, the clearing house collateral management system, through the performance bond processor 206, may analyze all users' portfolios to attempt to identify users with pending margin calls. Once identified and confirmed, the excess collateral credit from the first user may be matched with the second user, and transferred for the second user's use.

In one example, the user at a clearing house 140A may utilize an enhanced clearing house collateral management system, in accordance with various aspects of the disclosure, to transfer the collateral credits to another user at a different clearing house 140B. The enhanced clearing house collateral management system may use one or more components/modules/processors, such as the performance bond processor 206, to communicate over a network with the other clearing house 140B to transfer the collateral credits. The request may include the amount of collateral credits to transfer and identification of the recipient of the credits. The receiving clearing house 140B may include a clearing house collateral management system that generates a message to permit the recipient user (e.g., the second user) to confirm acceptance of the incoming collateral credits. In one example, the underlying collateral assets may reside at clearing house 140A, but an agreement may be created through the communication to secure the collateral towards the margin requirements of the recipient user's portfolio at clearing house 140B. In some examples, the communication may include communication to create a binding agreement between the two clearing houses 140A, 140B as to collateral for risk management of user portfolios.

The performance bond processor 206 may also facilitate transmission of collateral. The performance bond processor 206 may receive collateral assets from the user and record the collateral amount in memory 204 at the clearing house collateral management system. The performance bond processor 206 may also be configured to release the collateral asset back to the user when appropriate. In some examples, the clearing house collateral management system may take physical possession of collateral, but in other examples the performance bond processor 206 may cause the collateral assets received from the user to be secured at a remote location, such as by receiving/releasing the collateral through the securing of legal rights to the collateral assets (e.g., by causing the recording of appropriate security interest documents with the appropriate entities/governmental authorities, or placing an encumbrance on the legal title of an asset.) As such, the actual collateral asset might not need be physically delivered to a clearing house 140, but may be secured through legal techniques. The collateral asset may be a non-cash asset or cash.

Yet another module/processor/component described in the example of FIG. 2 is the market data module 112. The market data module 112 may perform mark-to-market assessments of financial instruments at regular intervals (e.g., daily, weekly, hourly, continuously, etc.) One or more of these financial instruments may be a part of a user's portfolio. Aspects of the mark-to-the-market settlement system stands in contrast to the settlement systems implemented by some other financial markets, including the Treasury securities, over-the-counter foreign exchange and debt, options, and equities markets, where participants regularly assume credit exposure to each other. In those markets, the failure of one participant can have a ripple effect on the solvency of the other participants. Conversely, the mark-to-the-market system does not allow losses to accumulate over time or allow a market participant the opportunity to defer losses associated with market positions. One of skill in the art after review of the entirety disclosed herein will appreciate that assessments other than mark-to-market are contemplated by the disclosure and other comparable assessments may be performed by the market data module 112 while remaining in accordance with various aspects of the disclosure.

In a mark-to-market settlement process involving forward contracts, instead of daily banking of settlement variation amounts, the total mark-to-market amount may simply be collateralized. In other words, all mark-to-market amounts for a user's portfolio may be netted together, and for each settlement currency, the net amount may become either a performance bond asset (if the firm is making money on its trades denominated in that currency) or a liability (if the firm is losing money on its trades denominated in that currency). On the morning of the value date, when the trades for a currency pair and that value date have been delivered, the mark-to-market amount for those trades may be removed from the total amount being collateralized. In some examples, a “cumulative mark-to-market calculation” for forward contracts includes all trades executed for that contract. For each such trade, the mark-to-market amount from original trade price to today's end-of-day settlement price is calculated, and the sum of these mark-to-market amounts is taken. Other approaches may involve using forward points to generate a spot rate to simplify the mark-to-market calculation.

One or more of the aforementioned functionality may be performed by the market data module 112 alone, or by the market data module 112 in combination with or with the assistance of another module/processor. For example, a clearing house may publish an end-of-day settlement price for every forward for which there is open interest, and every day it may calculate the total mark-to-market for all open trades.

In addition, the risk management module 134 of the clearing house collateral management system may be used in conjunction with one or more of the aforementioned components. Although in some examples the risk management module 134 may perform the steps of offsetting the performance bond requirement corresponding to a user's portfolio using a credit resulting from at least an increased valuation of the user's portfolio, in other examples the risk management module 134 may operate in combination with other components described herein, such as the performance bond processor 206, to provide the aforementioned functionality.

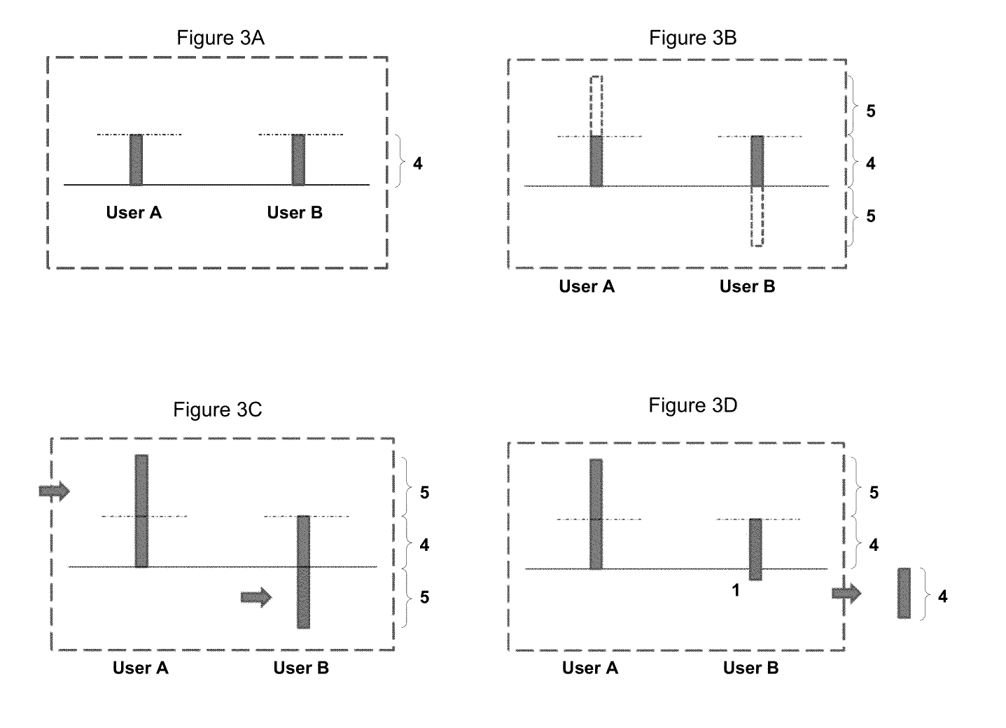

FIG. 3 is a graphical illustration of one embodiment of a method of transferring excess collateral between clearing members in accordance with aspects of the disclosure. Referring to FIG. 3A, User A holds a long position in a financial instrument. Meanwhile, User B holds a short position in the same financial instrument. The clearing house collateral management system may require each user to post four units of collateral to the clearing house based on the risk associated with the financial instrument. At the start of the transaction, each user may have posted the same amount of collateral assets to the clearinghouse collateral management system. Next, in FIG. 3B, the mark-to-market value of the financial instruments has changed such that User A must provide five additional units of collateral to be clearing house collateral management system. In this case, the financial instruments incurred a large cumulative price movement such as a price fall created a collateral variation margin requirement. As a result, User B receives collateral credit from the clearinghouse collateral management system in the amount of five units.

In some aspects of the disclosure, the financial instrument being held in the portfolio of User A and User B may include at least forward contracts and other financial instruments with similar characteristics. Forward contracts, unlike futures contracts (e.g., swaps and options), are held open until maturity and delivered at their original trade price. Futures are delivered at a final settlement price. A daily mark-to-market occurs of open positions with both types of contracts, but in the case of forward contracts, the amounts are net together and collateralized. The collateralization may result in the net being turned into a performance bond credit or debit (e.g., a clearing house may require the user to deposit addition collateral assets), as show in FIG. 3B. In the case of a futures contract, the results of daily mark-to-market are banked, and not collateralized this way. Forward contracts as used in this disclosure include, but are not limited to forward swap contracts (e.g., a calendar spread between two forwards, such as a “spot-1week” swap). When trades in forward swaps are received, they may be decomposed into transactions in the individual legs for clearing processing—similar to the way trades in futures calendar spreads are handled.

In FIG. 3C, User A has a total of nine units of collateral posted for margin: four of the units were from the initial performance bond and the additional five were based on price fluctuations determined by a mark-to-market calculation. Meanwhile, User B, which was only required to post four units of collateral, has received five units of collateral credit from the clearinghouse based on the mark-to-market calculation. In prior art systems, User B would not be able to make full efficient use of this collateral credit. An enhanced clearinghouse collateral management system, numerous embodiments of which are described in this disclosure, permits a more efficient use of the collateral credit. In FIG. 3D, User A has posted nine units of collateral to the clearing house for its long position in the financial instrument. However, User B is able to apply its five units of collateral credit from the clearinghouse towards the performance bond requirement. As a result, User B is able to retrieve (and the clearing house is able to release) the initial four units of collateral User B initially deposited as collateral. However, User B is still left with one unit of excess collateral credit. User B may choose to offer this one unit of excess collateral credit to other members of the clearinghouse (or other persons/entities) for their use. As a result, User B may act as an initiating member and offer one unit of collateral credit to any responding members. The responding member may be User A, or it may be any other user. For example, the responding member may be a different user at the same clearinghouse that wishes to offset its performance bond requirement by one unit. In an alternate embodiment, the responding member and the initiating member may be the same user that wishes to apply excess collateral credits from one portfolio towards another portfolio belonging to the same user.

In addition, the responding member may pay User B a fee or other benefits in exchange for the one unit of collateral credit. One skilled in the art after review of the entirety disclosed herein, will appreciate that in other scenarios more or less collateral credit may be provided for user B's transfer to other users. For example, if in FIG. 3C the collateral credit paid by the clearinghouse to User B was only three units, then User B would only be able to get back three units of its own initial collateral from the margin account, but would still need to leave one unit of its own initial collateral assets in the margin account. On the other hand, if more than five units of collateral credit were paid, then in FIG. 3D, User B would have more than one unit of collateral credit at his/her disposal to offer to a responding member. Moreover, the value offered by the responding member may be a discount to the value of the collateral being offered. Such discount represents the value opportunity to the responding members, and similarly represents the cost of obtaining liquid collateral to the initiating member. Moreover the fee paid by the responding member to the initiating member may be in cash or other non-cash form, and may include an additional value representing the negotiated discount.

In accordance with various features described herein, the disclosure contemplates transfers of marketable collateral by the responding member that is other than cash. For example, the responding member may transfer collateral in another form to the initiating member at an appropriate discount. The initiating member may subsequently withdraw from the clearing house collateral management system this transferred collateral. An increased nominal amount of collateral will be returned by the initiating member in the subsequent. As such, the responding member has paid the equivalent of a fee, but in a non-cash form.

In another example in accordance with various aspects of the disclosure, a repo transaction as described above may be agreed upon for a term greater than one day. In such transactions, re-valuation of the excess collateral credit may occur daily, but the transaction may be replicated at the agreed discount, provided that following the revaluation, an excess collateral continues to exist. At least one benefit of such an arrangement is that less manual work may be required of the users of the clearinghouse collateral management system.

In addition, although the user portfolio in numerous examples above has been described without reference to multiple portfolios, it is appreciated that the user portfolio may be multiple portfolios spread across a clearinghouse or multiple clearinghouses. As such, the collateral management system may calculate the performance bond requirements using the combination of the assets in the user's portfolios. For example, the collective assets of the user's portfolios may be such that less margin is required because of the nature of the assets balancing the risk of the portfolio.

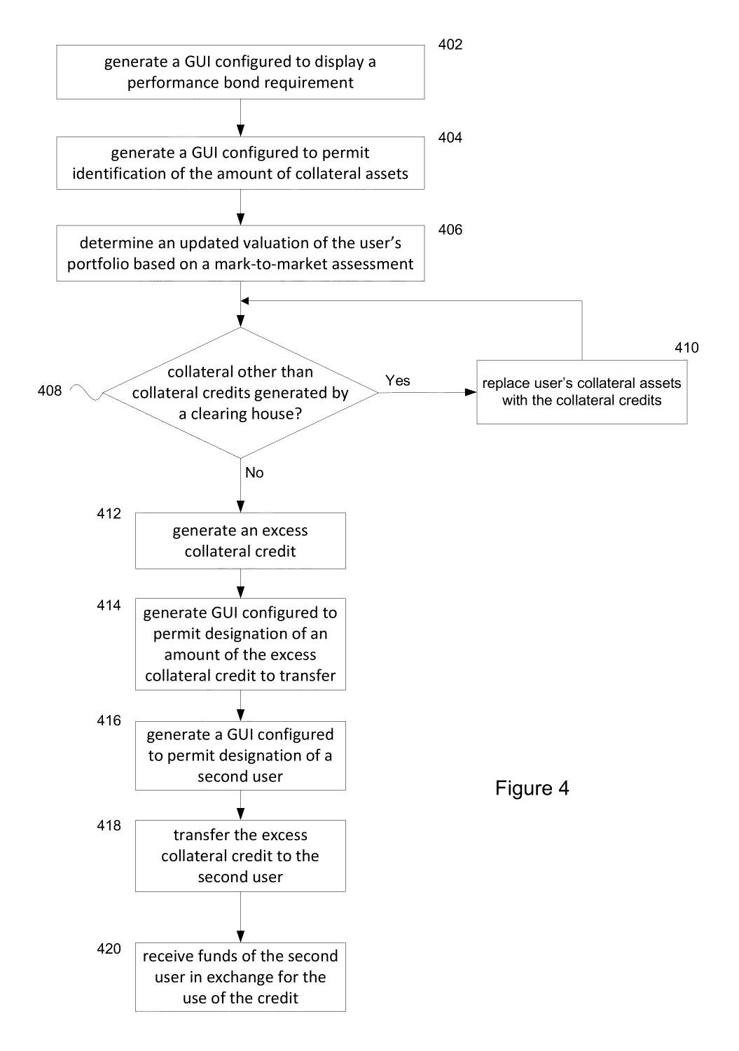

Moreover, the excess collateral credit achieved by User B, may be provided to the clearing house 140A, such that the clearing house may take responsibility for offering the collateral credit to other users. The clearing house may also, in some examples, collect a fee for the transaction. In other examples, User B may directly correspond with other users to offer and transfer the collateral credit. A graphical user interface (GUI) may be provided by the clearing house collateral management system for the purposes of permitting User B to determine the amount of collateral credit it has earned, and to offer excess collateral credit to other users. See FIG. 4. The graphical user interface may also provide displays and controls to permit the user to evaluate the status of the user's portfolio and its corresponding collateral. Other user interfaces may also be made available to the user in accordance with various aspects of the disclosure, such as those to provide the functions, features, and components described herein.

Referring to FIG. 4, that figure is a flowchart illustrating various steps that may be performed in accordance with aspects of the disclosure. One or more of the illustrated steps may be performed in a different order than illustrated order and/or may be entirely omitted. In step 402, a computer system 100 may generate a graphical user interface configured to display a calculated amount of a performance bond requirement based on at least a user's portfolio. The user's portfolio may comprise at least forward contracts and/or financial instruments for which increases in the financial instrument's value, which are determined through a mark-to-market assessment, are collateralized as credits towards the performance bond requirement of the user's portfolio. In step 404, the computer system 100 may generate a graphical user interface configured to permit designation of the amount of collateral assets to apply to the performance bond requirement of the user's portfolio. The graphical user interfaces generated in step 402, step 404, and other steps may be displayed at the same time (e.g., on a single webpage) or at a different time (e.g., on different webpages) on a user's display (e.g., a computer monitor).

In step 406, a computer system 100 may determine an increased valuation of the financial instruments (e.g., forward contracts) in the user's portfolio based on an updated price based on a mark-to-market assessment. The updated price based on a mark-to-market assessment may be received from a market data module 112, in some examples. In step 408, as illustrated in FIG. 3D, if all of the collateral assets provided by the user have been released and replaced with collateral credits generated from a clearing house, then the increased valuation of the financial instruments in the user's portfolio results in excess collateral credits. On the other hand, if the user's collateral assets remain held up as performance bonds, then in step 410, the increased valuation may be applied towards these remaining collateral assets, such as in FIG. 3D. In FIG. 3D, four units of collateral assets are released and returned to the user for use; meanwhile, one unit of collateral remains (i.e., excess collateral credit) as a result of the collateral credit shown in FIG. 3C. For example, in step 412, a computer system 100 may generate an excess collateral credit in the amount of a difference between the increased valuation of the user's portfolio and an amount of collateral assets applied to the performance bond requirement. In FIG. 3D, the excess collateral credit is one unit.

In step 414, a computer system 100 may generate a graphical user interface configured to permit designation of an amount of the excess collateral credit to transfer to a second user. In the example of FIG. 3D, the excess collateral credit amount is at most one unit. The user may designate one unit or less of excess collateral credits to transfer to another user in exchange for a fee or other benefit. In some examples, the user may designate an excess collateral credit amount and allow a clearing house (e.g., a collateral management system) or other entity to find and match the credit with another user (e.g., clearing member, trader, etc.) requiring collateral to meet a performance bond requirement. However, in other examples, a computer system 100 may generate (in step 416) a graphical user interface configured to permit designation of a recipient (e.g., a second user). In some examples, the second user's portfolio may be associated with a different clearing house 140B than the clearing house 140A associated with the user's portfolio.

In step 418, a computer system 100 may transfer the amount of the excess collateral credit from the user to the second user. The excess collateral credit may be provided to the second user's clearing house 140B to apply against any outstanding margin requirements on the second user's portfolio. The clearing house 140B may alternatively apply the credit towards other purposes designated by the second users. In exchange, in step 420, the second user's clearing house 140B may authorize the payment of a fee (e.g., an interest payment) to clearing house 140A. The user may receive, through its clearing house 140A, funds (e.g., cash or non-cash value) of the second user for the use of the collateral credit amount. In some examples, the clearing house 140A may also receive a fee or other benefit for providing the aforementioned features of FIG. 4.

The disclosure has been described herein with reference to specific exemplary embodiments thereof. It will be apparent to those skilled in the art after review of the entirety disclosed herein, that a person understanding this disclosure may conceive of changes or other embodiments or variations, which utilize the principles of this disclosure without departing from the broader spirit and scope of the disclosure as set forth in the appended claims. All are considered within the sphere, spirit, and scope of the disclosure. For example, although numerous examples refer to forward contracts in a user's portfolio, other financial instruments with similar characteristics may be used in accordance with various aspects of the disclosure, and the disclosure contemplates these other uses. The features and aspects described herein may be applied with respect to collateralized variation margin with respect to contracts other than forwards (e.g., swaps, options.) In addition, the disclosure contemplates contracts/instruments in numerous contexts, including, but not limited to, currency markets, interest rates, equities, commodities, and derivative contracts on various underlying items. Those skilled in the art after review of the entirety disclosed herein will appreciate that aspects of the disclosure may be used in other ways, but still fall within what is contemplated by the disclosure.

What is claimed is:

1. A computer-assisted method comprising:
calculating an amount of a performance bond requirement based on at least a user's portfolio, wherein the user's portfolio comprises at least forward contracts;
receiving a collateral asset from the user to allocate towards the performance bond requirement of the user's portfolio;
offsetting the performance bond requirement using a credit resulting from at least an increased valuation of the user's portfolio, wherein the credit is greater than a value of the collateral asset allocated towards the performance bond requirement;
releasing the collateral asset back to the user;
calculating an excess collateral credit amount equal to an amount of credit greater than the performance bond requirement;
transferring the excess collateral credit amount from the user to a second user; and
offsetting a performance bond requirement of the second user's portfolio using the excess collateral credit amount.

2. The method of claim 1, wherein the transferring of the excess collateral credit amount is temporary, the method further comprising:
transferring the excess collateral credit amount back to the user upon expiration of a predetermined period of time; and
transferring a fee amount from the second user to the user for the use of the excess collateral credit amount for the predetermined period of time.

3. The method of claim 2, where in the predetermined period of time is one business day, the method further comprising:
identifying the second user from among a plurality of users, wherein the second user requires additional collateral assets to meet its performance bond requirement; and
matching the excess collateral credit amount with the second user.

4. The method of claim 2, wherein the fee amount is an interest rate charged on the collateral credit amount.

5. The method of claim 1, further comprising:
receiving assets from the second user to the user in exchange for the use of the collateral credit amount.

6. The method of claim 1, wherein the collateral asset received from the user is a non-cash asset.

7. The method of claim 1, further comprising:
causing the collateral assets received from the user to be secured at a remote location.

8. The method of claim 1, further comprising:
receiving, using a market data module, an updated price of the forward contracts in the user's portfolio through a mark-to-market process, wherein the forward contracts is an exchange-traded financial instrument; and
determining that the updated price of the forward contracts increased value of the user's portfolio by more than the value of the collateral assets allocated towards the performance bond requirement.

9. The method of claim 1, wherein the user's portfolio comprises financial instruments for which increases in the financial instrument's value, which are determined through a mark-to-market assessment, are collateralized as credits towards the performance bond requirement of the user's portfolio.

10. The method of claim 1, wherein the user and the second user represent the same user.

11. The method of claim 1, where the user's portfolio was cleared at a first clearing house, and the second user's portfolio was cleared at a second clearing house.

12. A computer system comprising:
a computer processor;
a tangible computer memory storing computer-executable instructions, which when executed by the processor, cause the computer system to perform steps comprising:
calculating, using a performance bond processor, an amount of a performance bond requirement based on at least a first user's portfolio;
offsetting, using the risk management module, the performance bond requirement using a credit resulting from at least an increased valuation of the first user's portfolio, wherein the credit is greater than a value of a collateral asset allocated towards the performance bond requirement;
calculating, using the performance bond processor, a collateral credit amount equal to an amount of the credit greater than the performance bond requirement; and
transferring the collateral credit amount from the first user to a second user.

13. The system of claim 12, wherein the memory further stores computer-executable instructions, which when executed by the processor, cause the computer system to perform steps comprising:
offsetting, using the performance bond processor, a performance bond requirement of the second user's portfolio using the collateral credit amount; and
transferring funds from the second user to the first user in exchange for the use of the collateral credit amount.

14. The system of claim 12, wherein the first user's portfolio comprises at least forward contracts, and wherein the first user's portfolio was cleared at a first clearing house, and the second user's portfolio was cleared at a second clearing house.

15. The system of claim 12, wherein the first user's portfolio comprises financial instruments for which increases in the financial instrument's value, which are determined through a mark-to-market assessment, are collateralized as credits towards the performance bond requirement of the first user's portfolio.

16. The system of claim 12, wherein the memory further stores computer-executable instructions, which when executed by the processor, cause the computer system to perform steps comprising:
receiving, using the performance bond processor, the collateral asset from the first user to allocate towards the performance bond requirement of the first user's portfolio; and
releasing, using the performance bond processor, the collateral asset back to the first user after the calculating of the collateral credit amount greater than the performance bond requirement.

17. A tangible computer-readable medium storing computer-executable instructions, which when executed by a computer system, cause the computer system to perform steps comprising:
generating a first graphical user interface configured to display a calculated amount of a performance bond requirement based on at least a user's portfolio, wherein the user's portfolio comprises at least forward contracts;
determining an increased valuation of the forward contracts in the user's portfolio based on an updated price received from a market data module based on a mark-to-market assessment;
generating an excess collateral credit in the amount of a difference between (i) the increased valuation of the user's portfolio and (ii) an amount of collateral assets applied to the performance bond requirement, wherein the collateral assets are other than collateral credits generated by a clearing house;
generating a second graphical user interface configured to permit designation of an amount of the excess collateral credit to transfer to a second user; and
transferring the amount of the excess collateral credit from the user to the second user.

18. The computer-readable medium of claim 17 storing further computer-executable instructions, which when executed by a computer system, cause the computer system to perform steps comprising:
generating a third graphical user interface configured to permit designation of the amount of collateral assets to apply to the performance bond requirement of the user's portfolio.

19. The computer-readable medium of claim 19 storing further computer-executable instructions, which when executed by a computer system, cause the computer system to perform steps comprising:
generating a third graphical user interface configured to permit designation of the second user, wherein the user's portfolio is at a different clearinghouse than the second user's portfolio.

20. The computer-readable medium of claim 17 storing further computer-executable instructions, which when executed by a computer system, cause the computer system to perform steps comprising:
receiving funds of the second user for the use of the collateral credit amount.
